(19) United States
(12) Patent Application Publication
(10) Pub. No.: US 2008/0148140 A1
(43) Pub. Date: Jun. 19, 2008

(54) Spreadsheet In-Cell Graphical Display Method

(76) Inventor: Kimiyasu Nakano, Mie (JP)

Correspondence Address: OLIFF & BERRIDGE, PLC, P.O. BOX 320850, ALEXANDRIA, VA, 22320-4850, US

(21) Appl. No.: 11/663,439

(22) PCT Filed: Dec. 21, 2005
(86) PCT No.: PCT/JP05/23501

§ 371 Date: Mar. 21, 2007

(30) Foreign Application Priority Data
Dec. 21, 2004 (JP) 2004-368729

(51) Int. Cl. G06F 17/00

(52) U.S. Cl. 715/215

(57) ABSTRACT

An object of the present invention is to conveniently visualize data represented as a ratio or range in a cell of a spreadsheet. A ratio graph image having the length of the ratio to the width of the cell to which the ratio data is input is created and the ratio graph image is located in a predetermined cell. When the size of the ratio graph is changed, the size of the ratio graph is accordingly drawn again to represent the accurate ratio at all times. By registering data in various units in ratio data definition information, the type of data which can be represented in a graphic form is extended.

### TECHNICAL FIELD

The present invention relates to a spreadsheet program performed in a computer, particularly to a method of displaying a graph of data which can be represented as a ratio in a cell of a spreadsheet.

### BACKGROUND ART

Spreadsheets (spreadsheet softwares) for accumulating and analyzing data by using a computer have been widespread. The spreadsheets may handle data which can be represented as a ratio to a predetermined basic number, such as a numeric value represented as simple percentages, months to a year and hours to a day, (which are hereinafter referred to as ratio data). Although such ratio data represented as original values can be understood, the data represented in a visualized state can be understood more easily.

As a possible method of visualizing the ratio data, a graph drawing function inherent in most spreadsheets may be used. By using the graph drawing function, a relation between the data in a plurality of cells can be visualized into a figure suitable for characteristics of the data (e.g. broken line, bar, circle, and scatter diagram). The type of figure as well as details including a graph shape, a graph scale and color of each part of components of the graph can be changed. That is, since various data can be effectively visualized by using the graph drawing function, meaning and significance of data can be rapidly recognized.

For the graph drawing function, generally, operations and settings for graph drawing need to be performed one by one. Thus, a large amount of ratio data causes troublesome tasks. In addition, it is generally necessary to arrange the drawn graph according to the position of a cell so that it can be readily visible. As well known, it is a work which requires a lot of time and effort. As described above, since ratio data represented as original values can be understood, it is undesirable for the user to spend time and effort for the visualizing work than necessary.

Accordingly, as another method of visually representing the ratio data, a display format of a cell itself is changed according to a data value input in the cell. As such art, Patent document 1 discloses a cell highlight and modification method by which highlight and modification of cell color, font, display format and so on are dynamically performed according to conditions designated in the spreadsheet by the user. Patent Document 2 discloses a cell data highlight display method of automatically setting background color and shading of a cell according to a value input in the cell and changing the background color of the cell when the value is changed.

[Patent document 1] Unexamined Japanese Patent Publication No. H6-274515

[Patent document 2] Unexamined Japanese Patent Publication No. H11-282941

### DISCLOSURE OF THE INVENTION

### Problem to be Solved by the Invention

The methods of changing the display format of the cell according to a data value, as disclosed in Patent documents 1 and 2, are convenient methods for visually representing the ratio data. However, only change of background color, character color and font cannot achieve the graph's effect in terms of that the user can intuitively grasp meaning of the data at one glance.

Therefore, an object to be solved by the present invention is to visualize the ratio data in the spreadsheet effectively and easily without requiring time and effort of the user.

### Means for Solving the Problem

The inventors have been dedicated to studying the above-mentioned object and then, noted that the cell in the spreadsheet is generally a horizontally long rectangle. As a result, the inventors have thought of displaying a graph in the cell. An in-cell graphical display method according to the present invention thus invented is characterized by calculating ratio according to a data format of the data based on the data in the cell of the spreadsheet and displaying a ratio graph showing the ratio in the predetermined cell.

In this description, “cell width” refers to the length of long sides of a cell, that is, the length of the cell in the horizontal direction in general spreadsheets. “Cell thickness” refers to the length of short sides of the cell, that is, the length of the cell in the vertical direction.

### EFFECT OF THE INVENTION

According to an in-cell graphical display method of the present invention, the ratio of the ratio data in the cell can be conveniently represented in a graphical form and displayed in another cell or the own cell. Consequently, the user can visually grasp meaning and significance of the ratio data rapidly and easily. Furthermore, since the ratio graph is displayed in one cell, as compared with the case where a graph is created by using the graph drawing function generally provided in the spreadsheet, time required for setting and arrangement is greatly reduced.

### BRIEF DESCRIPTION OF THE DRAWINGS

FIG. 1 is a block diagram showing configuration of a main part of a computer system according to an embodiment of the present invention.

FIG. 2 is a view showing structure of ratio data definition information.

FIG. 3 is a view showing structure of ratio graph setting information.

FIG. 4 is a flow chart of an in-cell graphical display processing program.

FIG. 5 is a view showing a screen on which ratio graphs are displayed in cells.

FIG. 6 is a view showing a screen in the case where the size of a cell is changed.

FIG. 7 is a view showing a screen on which ratio graphs are displayed based on ratio data in a plurality of cells.

FIG. 8 is a view showing a screen on which ratio graphs are displayed in the case where the ratio value is larger than 1.

FIG. 9 is a view showing another example of ratio graph images.

FIG. 10 is a view showing a screen on which a ratio graph is displayed in the case where ratio data is ratio.

FIG. 11 is a view showing a screen on which ratio graphs are displayed in the case where long sides of the cell extend along the vertical direction.

FIG. 12 is a view showing a screen in accordance another embodiment of the present invention.

FIG. 13 is a view showing a screen on which range graphs are displayed in cells.

### EXPLANATION OF NUMERALS

1 . . . . Computer system
2 . . . CPU
3 . . . Memory
4 . . . Display unit
5 . . . Input unit
6 . . . Storage unit

### BEST MODES FOR CARRYING OUT THE INVENTION

Hereinafter, embodiments of the present invention will be described referring to figures.

First, configuration of the present invention will be described.

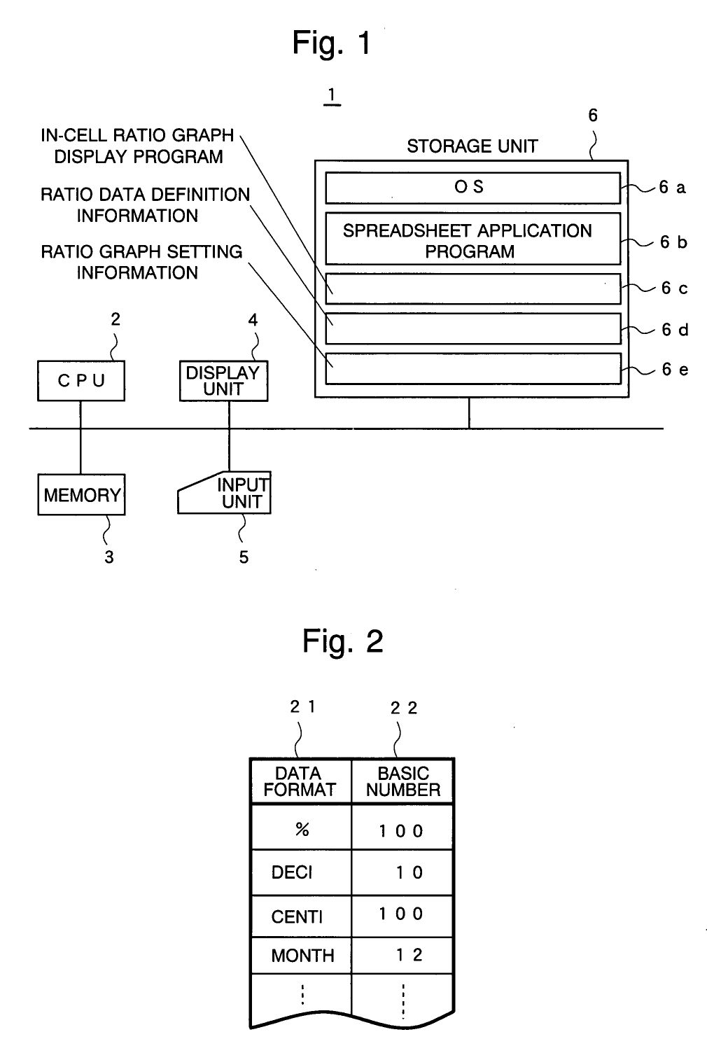

FIG. 1 is a block diagram showing configuration of a main part of a computer system 1 according to the present embodiment. The computer system 1 is configured so that a CPU 2, a memory 3, a display unit 4 formed of a CRT (Cathode Ray Tube) display or liquid crystal display, an input unit 5 formed of a keyboard having character and numeric keys and various functional keys and a mouse as a pointing device, and a storage unit 6 may be interconnected. The storage unit 6 has a storage medium such as a magnetic recording medium, an optical recording medium or a semiconductor memory, which previously stores programs and data therein. The storage medium may be fixed to the storage unit 6 or detachably provided. The storage unit 6 stores an OS (Operating System) 6a, a spreadsheet application program 6b, an in-cell graphical display program 6c, ratio data definition information 6d and a ratio graph setting information 6e therein.

FIG. 2 shows a structure of the ratio data definition information 6d. The ratio data definition information 6d stores a data format 21 showing units which can be handled as ratio data and a basic number 22 of the data format therein. The case where month is handled as the ratio data to a year is used as an example. In this case, the basic number is 12 and a ratio value of the input month number to 12 is calculated. That is, the ratio data of “May” has a ratio value of 5/12≈0.417 . . . .

This ratio data definition information can be freely set or changed by the input unit 5.

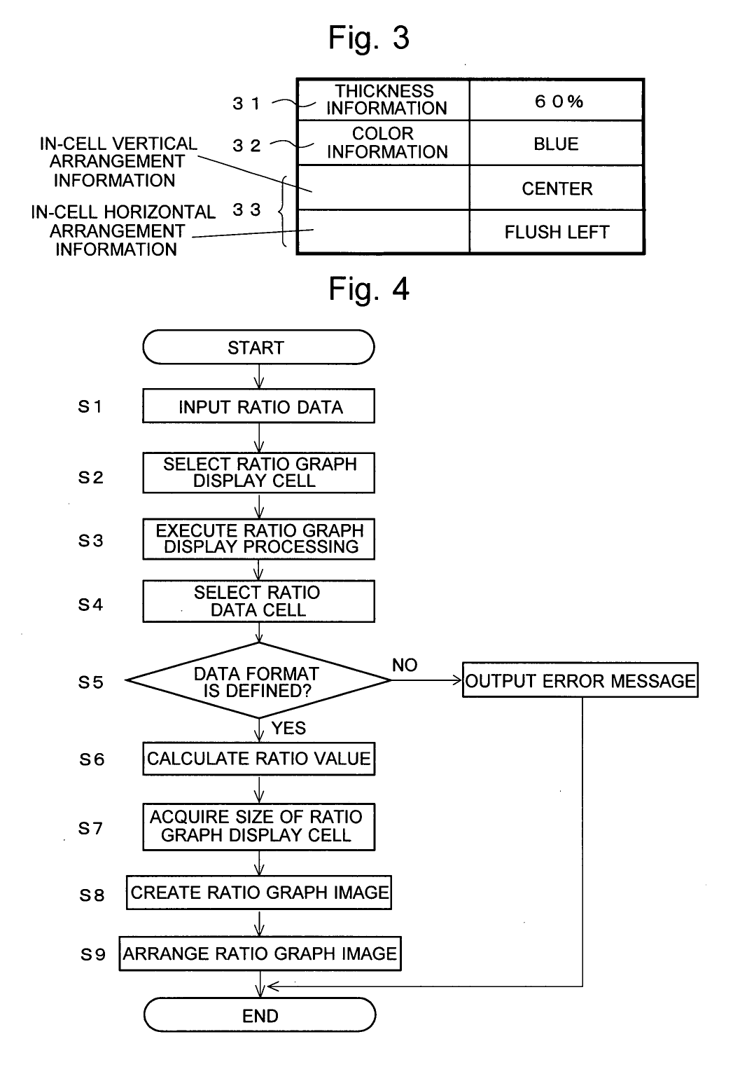

FIG. 3 shows structure of the ratio graph setting information. The ratio graph setting information stored information on the display format necessary for creating a ratio graph image and arrangement information for arranging the ratio graph image therein.
Thickness information 31 which designates thickness of the ratio graph
Color information 32 which designates color of the ratio graph
In-cell arrangement information 33 which designates arrangement position of the ratio graph in the cell

The ratio graph setting information can be freely set or changed by the input unit 5.

Next, the in-cell graphical display processing executed by performing an in-cell graphical display program (which is hereinafter referred to as a program) by the CPU 2 will be described referring to a flow chart in FIG. 4.

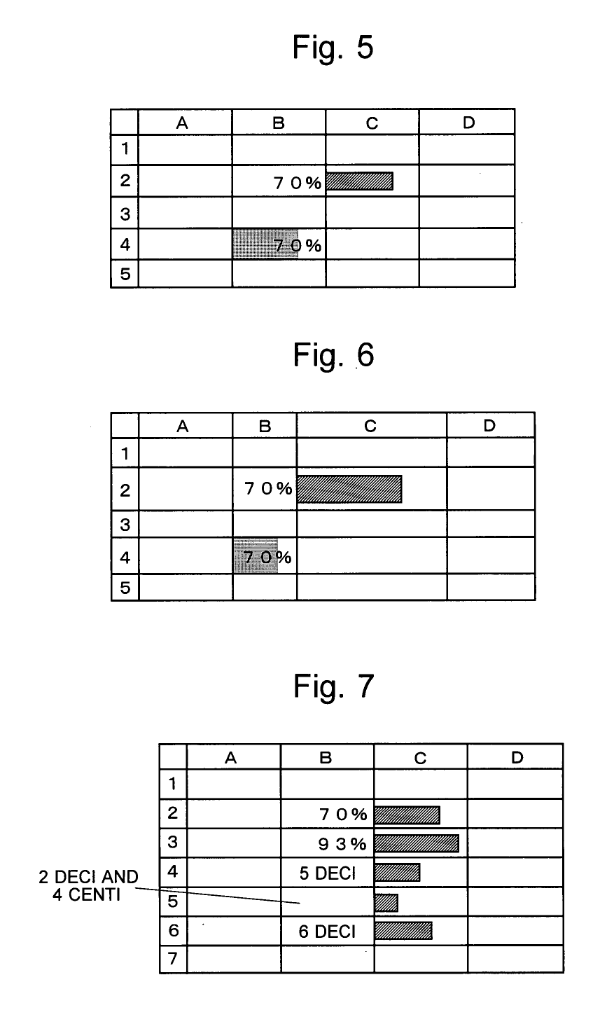

First, the ratio data is input in an arbitrary cell (hereinafter referred to as ratio data cell) in the spreadsheet (step S1). Here, given that “70%” is input in a cell B2 in the spreadsheet (FIG. 5). The ratio data may be directly input by the input unit 5 or automatically input in the cell as a result of some calculation processing.

A cell in which the ratio graph is displayed (hereinafter referred to as ratio graph display cell) is selected by the input unit 5 (step S2). In the present embodiment, a cell C2 is selected. The ratio data cell may be the same as the ratio graph display cell (for example, a cell B4 in FIG. 5). Next, execution of the in-cell graphical display processing is instructed according to the input by the input unit 5 (step S3).

When the ratio data cell (cell B2) having the ratio data as a basis of the ratio graph is selected (step S4), the program confirms whether or not the ratio data is the data format defined in the ratio data definition information (step S5).

When the data format is not defined, a predetermined error message is displayed to finish the in-cell graphical display processing.

When the data format is defined, the operation proceeds to a step S6 to calculate the ratio value. “70%” input in the ratio data cell in the present embodiment has the data format of “%” and the basic number of “100”, the ratio value is calculated as 0.7 based on 70/100.

Subsequently, the program acquires values of width and thickness as size of the ratio graph display cell (step S7). In the present embodiment, the values of width and thickness are 80 pixels and 20 pixels, respectively.

Based on the ratio value calculated at the step S6, the width and thickness of the ratio graph display cell which are acquired at the step S7, and the thickness information 31 and the color information 32 which are stored in the ratio graph setting information, a rectangular image having the following characteristics is created (step S8). The thickness information is supposed to be 60%.
Width: 80×0.7=56 pixels
Thickness: 20×0.6=12 pixels
Color: blue

Next, at a step S9, based on the in-cell arrangement information 33 stored in the ratio graph setting information, the program locates the image of the ratio graph flush left in the horizontal direction and at the center in the vertical direction in the ratio graph display cell and displays the image on the display as the display unit 4 (FIG. 5). Then, the processing is finished.

By displaying the ratio graph in the cell in the spreadsheet in this manner, the ratio data is conveniently visualized.

Generally, the size of the cell in the spreadsheet can be freely changed. However, when the size of the ratio graph display cell is changed, it is preferred that the processing at the steps S7 to S9 is executed again so that the ratio graph may represent the ratio corresponding to the width of the new ratio graph display cell (FIG. 6).

In the above-mentioned embodiment, one ratio data cell is designated and the ratio graph is displayed in one ratio graph display cell. However, as shown in FIG. 7, as a matter of course, it is possible to selectively designate a plurality of ratio data cells at one time and create a ratio graph for each of the ratio graph display cells corresponding to the ratio data cells.

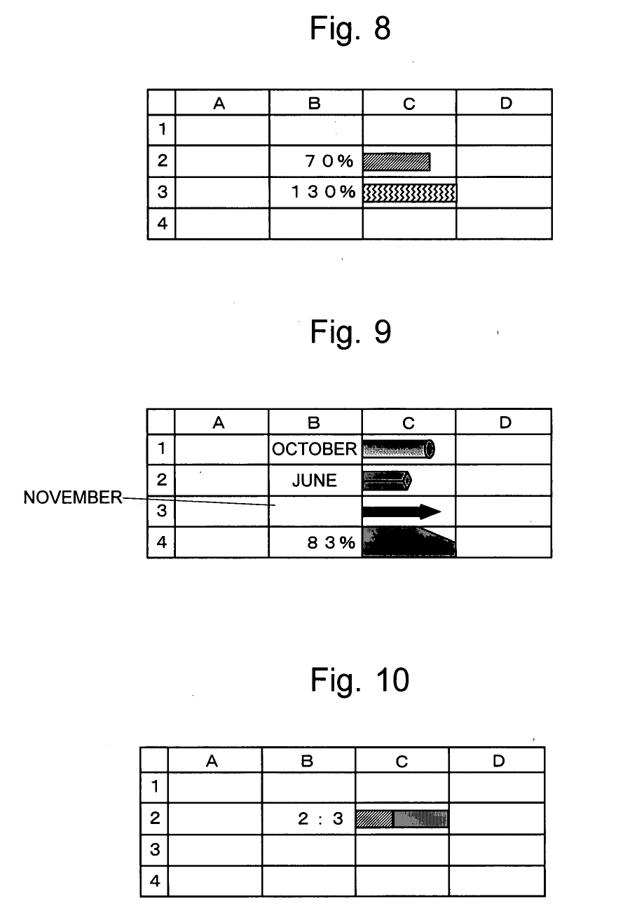

In the above-mentioned embodiment, the ratio value is 0.7. However, the ratio value may be larger than 1. In this case, the size of the ratio graph becomes larger than the cell width and thus, the ratio graph does not fit within the cell. To solve this problem, in the ratio graph setting information, when the ratio value is larger than 1, the ratio value is set to 1 and color of the ratio graph can be set to a specified color such as red (FIG. 8).

To improve visually recognition effect, it is possible to set hue, density and saturation of the ratio graph in the color information 32 of the ratio graph setting information so as to change according to the ratio value.

The ratio graph image is not limited to rectangle and may be formed in any shape as long as it can represent its ratio. For example, as shown in FIG. 9, three-dimensional images (cells C1, C2 in FIG. 9) and an arrow (cell C3 in FIG. 9) may be used. Alternatively, it is possible to set an arbitrary image in advance and scale up or down the image based on the ratio value and the thickness information to be the ratio graph image. As shown in a cell C4 in FIG. 9, it is also possible to fill the cell by an area corresponding to the ratio value.

In the above-mentioned embodiment, the data format is formed of a single unit. However, the ratio data definition information 6d can be set so that the ratio value may be calculated even in the case of the data format formed of a plurality of units. In this case, definition to convert the plurality of units into a single unit is made. For example, “2 deci and 4 centi” is converted into “2.4 deci” and the ratio value of 2.4/10=0.24 is calculated (FIG. 7). “July 12” is converted into “193 days” based on the number of days in each month and the ratio value of 193/365≈0.53 is calculated. As a result, since the user does not need to convert the unit, the ratio data can be visualized more conveniently and actively.

The ratio graph may be created based on a ration such as “2:3” as the ratio data. In this case, the width of the ratio graph is made identical to the width of the display cell and a left portion and a right portion of the ratio graph are represented in different colors according to the ratio of the ratio data (FIG. 10).

In the above-mentioned embodiment, the ratio graph display cell is designated and then the ratio data cell is designated. However, it is preferred that the processing can be executed even if the ratio data cell is first designated and then the ratio graph display cell is designated. Thus, since the ratio data can be visualized according to a plurality of operating methods, operability is further improved.

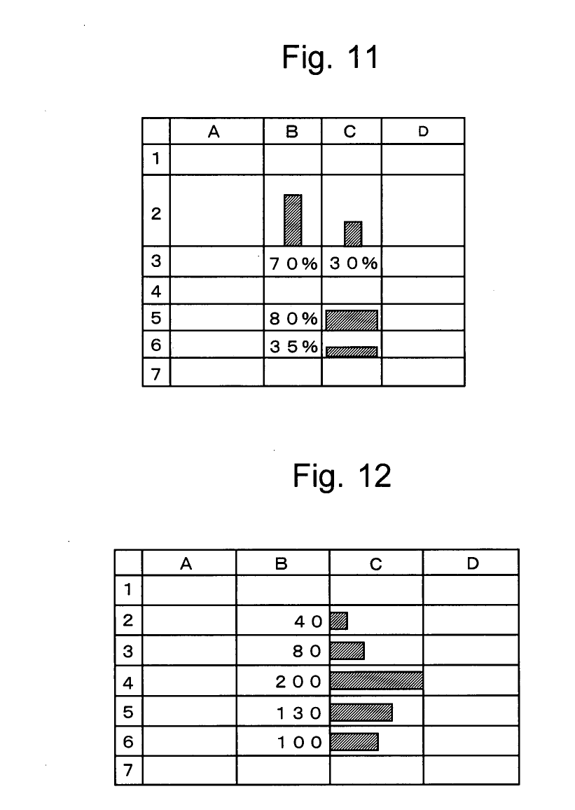

In some usages of the spreadsheet, long sides of the cell may extend in the vertical direction. In this case, as shown in FIG. 11, it is preferred that the ratio graph showing the ratio in the vertical direction of the cell can be created by defining the vertical direction as the cell width and the horizontal direction as the cell thickness (cell B2, cell C2 in FIG. 11). As a matter of course, even when the long sides of the cell extend in the horizontal direction, the ratio graph showing the ratio in the vertical direction of the cell may be created (cell C5, cell C6 in FIG. 11).

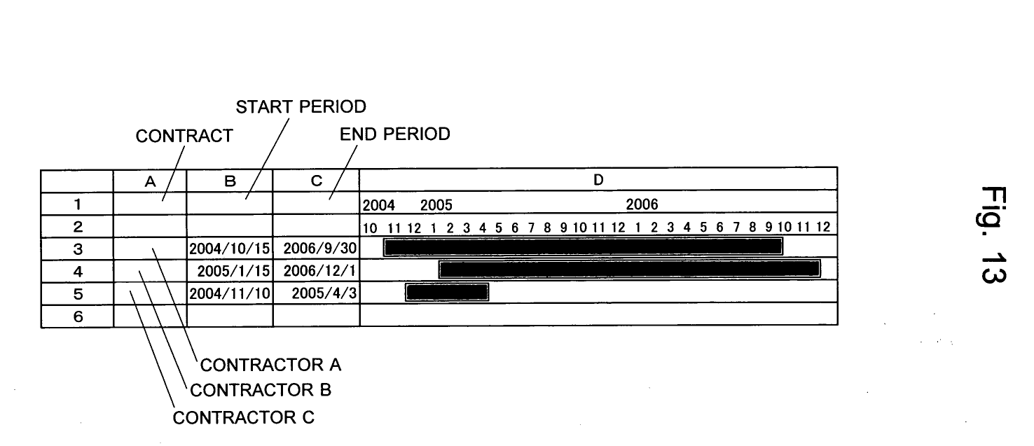

In another embodiment of the present invention, when a plurality of pieces of data in a plurality of cells are designated, the ratio value is calculated using a specific value such as a maximum value in these pieces of data as the basic number and the ratio graphs are generated based on the ratio value and located in a plurality of predetermined cells. For example, in FIG. 12, pieces of data 40, 80, 200, 130 and 100 are input in cells B2 to B6, respectively. When the range of the cells B2 to B6 is specified and the in-cell graphical display processing of the present invention is executed, the basic number is set to 200 based on that the maximum value is 200 and the ratio values of the pieces of data are calculated as 0.2, 0.4, 1, 0.65 and 0.5, respectively. According to the ratio values, the ratio graphs are created and each of the graphs is located in a designated cell (cells C2 to C6 in FIG. 12). In this manner, significance of plural pieces of data can be conveniently recognized with a small amount of work.

In the above-mentioned embodiment, a total value of data, which is a specific value of the plural pieces of designated data, may be used as the basic number. The ratio value or a percent value based on the ratio value may be overlappingly displayed on the ratio graph or may be displayed in the predetermined cell.

In another embodiment of the present invention, data representing a predetermined range or period may be visually represented as a range graph. An example in this case will be described referring to FIG. 13 which is a table showing a contract period for each contractor. First, to identify the range of data value displayed in a range graph display cell, a display minimum value and a display maximum value are set in advance. In this example, 2004/10/1 is set as the display minimum value and 2006/12/31 is set as the display maximum value. Next, a minimum value and a maximum value of the range data are designated. In this example, first, for the contract period of a contractor A, “2004/10/15” input in a cell B3 in FIG. 13 is set as the minimum value (start period) and “2006/9/30” input in a cell C3 is set as the maximum value (end period). Next, when the range graph display cell (cell D3) is designated, a range graph image having a width identified by the start period and the end period is created based on the cell width, the display minimum value and the display maximum value. The range graph image is located at a proper position in the range graph display cell. For contractors B and C, similar processing should be executed.

Also in the above-mentioned embodiment, when the size of the range graph display cell is changed, as in the case of the above-mentioned ratio graph, it is preferred that the range graph is drawn again so as to represent the range corresponding to the width of the new range graph display cell.

In the above-mentioned embodiment, as shown in cells D1 and D2 of FIG. 13, it is desirable to provide a scale based on the display minimum value and the display maximum value. For example, a scale image may be created and the scale image may be located in a cell designated as a scale display cell. By providing the scale, when the user refers to the range graph, the user can easily recognize the range represented by the scale.

In the above-mentioned embodiment, the display minimum value and the display maximum value are set in advance. However, when a plurality of pieces of data are set, a maximum value and a minimum value among them may be automatically set as the display minimum value and the display maximum value.

In the above-mentioned embodiment, the minimum value and the maximum value of the range data are input in different cells. However, these values may be input in the same cell. In this case, for example, both values only need to be marked off by using comma, space or semicolon as shown in “2004/10/5, 2006/9/30”.

The in-cell graphical display method of the present invention can be implemented as a macro in various spreadsheet application programs and may be incorporated as a kind of function. As a matter of course, the in-cell graphical display method can be applied to the spreadsheet application as well as various application programs having a spreadsheet function.

1-11. (canceled)

12. An in-cell graphical display method comprising:
calculating a ratio based on data in a cell of a spreadsheet according to a data format of the data; and
displaying a ratio graph showing the ratio in a predetermined cell.

13. The in-cell graphical display method according to claim 12, wherein the ratio graph is a graph having a width for the ratio with respect to a width of the cell which displays the ratio graph therein.

14. The in-cell graphical display method according to claim 12, wherein when a calculated ratio is larger than 1, the ratio is set to 1 and the display format such as shape and color of the graph is used as a predetermined display format.

15. The in-cell graphical display method according to claim 13, wherein when a calculated ratio is larger than 1, the ratio is set to 1 and the display format such as shape and color of the graph is used as a predetermined display format.

16. An in-cell graphical display method comprising:
calculating ratios based on data in a plurality of cells in a spreadsheet according to a preset specific value of the plurality of pieces of data; and
displaying ratio graphs showing the ratios in a plurality of predetermined cells.

17. The in-cell graphical display method according to claim 16, wherein the ratio graph is a graph having a width for the ratio with respect to a width of the cell which displays the ratio graph therein.

18. The in-cell graphical display method according to claim 16, wherein when a calculated ratio is larger than 1, the ratio is set to 1 and the display format such as shape and color of the graph is used as a predetermined display format.

19. The in-cell graphical display method according to claim 17, wherein when a calculated ratio is larger than 1, the ratio is set to 1 and the display format such as shape and color of the graph is used as a predetermined display format.

20. An in-cell graphical display method comprising:
identifying a data range based on a set of minimum value data and maximum value data in a plurality of designated cells of a spreadsheet; and
displaying a range graph showing the range based on a size of the predetermined cell, a display minimum value and a display maximum value in the predetermined cell.

21. The in-cell graphical display method according to claim 12, wherein the cell to which data is input is the same as the cell in which the graph is displayed.

22. The in-cell graphical display method according to claim 13, wherein the cell to which data is input is the same as the cell in which the graph is displayed.

23. The in-cell graphical display method according to claim 14, wherein the cell to which data is input is the same as the cell in which the graph is displayed.

24. The in-cell graphical display method according to claim 15, wherein the cell to which data is input is the same as the cell in which the graph is displayed.

25. The in-cell graphical display method according to claim 16, wherein the cell to which data is input is the same as the cell in which the graph is displayed.

26. The in-cell graphical display method according to claim 17, wherein the cell to which data is input is the same as the cell in which the graph is displayed.

27. The in-cell graphical display method according to claim 18, wherein the cell to which data is input is the same as the cell in which the graph is displayed.

28. The in-cell graphical display method according to claim 19, wherein the cell to which data is input is the same as the cell in which the graph is displayed.

29. The in-cell graphical display method according to claim 20, wherein the cell to which data is input is the same as the cell in which the graph is displayed.

30. The in-cell graphical display method according to claim 12, wherein when the size of the cell in which the graph is displayed is changed, display of the graph is changed so as to represent the ratio or range according to the size of the new cell.

31. The in-cell graphical display method according to claim 13, wherein when the size of the cell in which the graph is displayed is changed, display of the graph is changed so as to represent the ratio or range according to the size of the new cell.

32. The in-cell graphical display method according to claim 14, wherein when the size of the cell in which the graph is displayed is changed, display of the graph is changed so as to represent the ratio or range according to the size of the new cell.

33. The in-cell graphical display method according to claim 15, wherein when the size of the cell in which the graph is displayed is changed, display of the graph is changed so as to represent the ratio or range according to the size of the new cell.

34. The in-cell graphical display method according to claim 16, wherein when the size of the cell in which the graph is displayed is changed, display of the graph is changed so as to represent the ratio or range according to the size of the new cell.

35. The in-cell graphical display method according to claim 17, wherein when the size of the cell in which the graph is displayed is changed, display of the graph is changed so as to represent the ratio or range according to the size of the new cell.

36. The in-cell graphical display method according to claim 18, wherein when the size of the cell in which the graph is displayed is changed, display of the graph is changed so as to represent the ratio or range according to the size of the new cell.

37. The in-cell graphical display method according to claim 19, wherein when the size of the cell in which the graph is displayed is changed, display of the graph is changed so as to represent the ratio or range according to the size of the new cell.

38. The in-cell graphical display method according to claim 20, wherein when the size of the cell in which the graph is displayed is changed, display of the graph is changed so as to represent the ratio or range according to the size of the new cell.

39. The in-cell graphical display method according to claim 21, wherein when the size of the cell in which the graph is displayed is changed, display of the graph is changed so as to represent the ratio or range according to the size of the new cell.

40. The in-cell graphical display method according to claim 22, wherein when the size of the cell in which the graph is displayed is changed, display of the graph is changed so as to represent the ratio or range according to the size of the new cell.

41. The in-cell graphical display method according to claim 23, wherein when the size of the cell in which the graph is displayed is changed, display of the graph is changed so as to represent the ratio or range according to the size of the new cell.

42. The in-cell graphical display method according to claim 24, wherein when the size of the cell in which the graph is displayed is changed, display of the graph is changed so as to represent the ratio or range according to the size of the new cell.

43. The in-cell graphical display method according to claim 25, wherein when the size of the cell in which the graph is displayed is changed, display of the graph is changed so as to represent the ratio or range according to the size of the new cell.

44. The in-cell graphical display method according to claim 26, wherein when the size of the cell in which the graph is displayed is changed, display of the graph is changed so as to represent the ratio or range according to the size of the new cell.

45. The in-cell graphical display method according to claim 27, wherein when the size of the cell in which the graph is displayed is changed, display of the graph is changed so as to represent the ratio or range according to the size of the new cell.

46. The in-cell graphical display method according to claim 28, wherein when the size of the cell in which the graph is displayed is changed, display of the graph is changed so as to represent the ratio or range according to the size of the new cell.

47. The in-cell graphical display method according to claim 29, wherein when the size of the cell in which the graph is displayed is changed, display of the graph is changed so as to represent the ratio or range according to the size of the new cell.

48. A computer-readable recording medium that stores an in-cell graphical display program for reading data in a designated cell of a spreadsheet,
the program having instructions for causing a computer to:
calculate a ratio according to a data format of the data; and
display a ratio graph showing the ratio in a predetermined cell.

49. A computer-readable recording medium that stores an in-cell graphical display program for reading data in a plurality of designated cells of a spreadsheet, the program having instructions for causing a computer to:
calculate ratios according to a preset specific value of the plurality of pieces of data; and
display ratio graphs showing the ratios in a plurality of predetermined cells.

50. A computer-readable recording medium that stores an in-cell graphical display program, the program having instructions for causing a computer to:
identify a data range based on a set of minimum value data and maximum value data in a plurality of designated cells of a spreadsheet; and
display a range graph showing the range based on size of the predetermined cell, a display minimum value and a display maximum value in the predetermined cell.

51. The recording medium according to claim 48, wherein the graph is displayed in the same cell as the cell to which data is input.

52. The recording medium according to claim 49, wherein the graph is displayed in the same cell as the cell to which data is input.

53. The recording medium according to claim 50, wherein the graph is displayed in the same cell as the cell to which data is input.

54. A computer-readable recording medium that stores a control program for controlling a computer on which a spreadsheet application is installed, the spreadsheet application displaying a plurality of rows and columns of cells, each of the cells displaying a value assigned to the cell directly or as a result of a calculation of the spreadsheet application, the control program comprising instructions to:
display, in a cell of the spreadsheet application, a ratio graph that represents the value of a predetermined cell in relation to a maximum value, at least one dimension of the ratio graph being proportional to at least one dimension of the cell in which the ratio graph is displayed such that a ratio of the value of the predetermined cell to the maximum value is the same as a ratio of a dimension of the ratio graph to a dimension of the cell in which the ratio graph is displayed; and
adjust at least one dimension of the ratio graph if at least one dimension of the cell in which the ratio graph is displayed is changed, such that the ratio of the dimension of the ratio graph to the dimension of the cell in which the ratio graph is displayed remains the same as the ratio of the value of the predetermined cell to the maximum value.

55. The computer-readable recording medium of claim 54, wherein the cell in which the ratio graph is displayed is the predetermined cell with a value.

56. The computer-readable recording medium of claim 54, wherein the maximum value is determined by comparing the values of a range of cells and selecting the largest value.

57. The computer-readable recording medium of claim 54, wherein the value of the predetermined cell is a date.

58. The computer-readable recording medium of claim 57, wherein the maximum value is based on a date range entered by the user.

59. The computer-readable recording medium of claim 57, wherein the maximum value is a year.

60. The computer-readable recording medium of claim 54, wherein the ratio graph can be displayed such that a side of the ratio graph is offset from a side of the cell in which the ratio graph is displayed.

61. The computer-readable recording medium of claim 54, wherein a side of the ratio graph can be aligned with any side of the cell in which the ratio graph is displayed.

62. The computer-readable recording medium of claim 54, wherein the program includes an instruction to calculate and display a scale cell, in a cell different than the cell in which the ratio graph is displayed, such that the value of the ratio graph is apparent from comparison of the ratio graph with the scale cell.
